(19) United States
(12) Patent Application Publication
(10) Pub. No.: US 2025/0197237 A1
(43) Pub. Date: Jun. 19, 2025

(54) CO2 ASSISTED REGENERABLE SOLVENT AIDED SEPARATION OF HEAVY RARE EARTH ELEMENTS

(71) Applicant: CORNELL UNIVERSITY, Ithaca, NY (US)

(72) Inventors: Greeshma GADIKOTA, Ithaca, NY (US); Tianhe YIN, Ithaca, NY (US); Akanksha SRIVASTAVA, Edgewater, NJ (US)

(73) Assignee: CORNELL UNIVERSITY, Ithaca, NY (US)

(21) Appl. No.: 19/067,558

(22) Filed: Feb. 28, 2025

Related U.S. Application Data
(63) Continuation of application No. PCT/US2023/073219, filed on Aug. 31, 2023.
(60) Provisional application No. 63/374,338, filed on Sep. 1, 2022.

(51) Int. Cl. C01F 17/247; C22B 3/44; C22B 59/00; C25D 3/54

(52) U.S. Cl. CPC C01F 17/247; C22B 3/44; C22B 59/00; C25D 3/54; C01P 2002/72; C01P 2002/82; C01P 2002/88; C01P 2004/03

(57) ABSTRACT

Provided are methods for recovering a rare earth metal from an aqueous solution containing at least two metals. The methods entail: providing an aqueous solution containing rare earth metal ions from a rare earth metal and base metal ions from a base metal that is a transition metal; adding to the aqueous solution a solvent to capture carbon dioxide; and recovering the rare earth metal by: introducing a source of (bi)carbonate or carbamate anion into the solution, thereby forming a rare earth metal carbonate; forming a soluble base metal complex which enables separation of the rare earth element; and precipitating the rare earth metal carbonate from the aqueous solution, thereby forming a rare earth metal-depleted aqueous solution.

### CROSS REFERENCE TO RELATED APPLICATIONS

This application is a continuation of International Application No. PCT/US2023/073219, filed on Aug. 31, 2023 (which published as WO 2024/050462 on Mar. 7, 2024), which claims priority to U.S. provisional application No. 63/374,338, filed on Sep. 1, 2022.

### BACKGROUND

Climate change resulting from increased greenhouse gas emissions to the atmosphere is one of the most concerning environmental issues in this age. Policies such as the Paris Agreement of 2015 are being implemented to prevent warming of the planet reaching more than 1.5° C., and the rates of anthropogenic carbon dioxide emissions have slowly started to stabilize (albeit at high levels) over the last two decades. Even with the eventual reduction of emissions, however, carbon capture, utilization and storage (CCUS) methods will be required to bring greenhouse gas levels back to pre-industrial levels. CCUS involves repurposing captured greenhouse gas emissions—carbon dioxide in particular—for underground storage or use in other processes so that they are not released into the atmosphere.

Rare earth elements (REE) include the lanthanides row of the periodic table, scandium, and yttrium. They have a wide range of applications in modern electronics and technologies, including neodymium/dysprosium magnets, lanthanum-nickel thin films and electrodes, and nickel metal hydride batteries. As such, the demand for rare earths has significantly increased in recent years. From both an economic and political standpoint, however, supplying rare earth elements is becoming increasingly difficult. Currently, 97% of REE mining and extraction is conducted in China, with the remaining occurring in spots across the rest of the globe. While their designation as “rare” is somewhat of a misnomer in that they are found in several deposits globally, continued reliance on raw metal extraction for these elements will soon become an issue. Current industrial-scale methods for extraction typically involve solvent extraction, hydrometallurgical, and leaching methods.

Significant advances have been made in REE recovery. For example,

Kim et al., Rare Earth Element Recovery Using Monoethanolamine. J. of Materi Eng and Perform 29, 5564-5573 (2020) disclose recovery of aqueous REEs using monoethanolamine and carbon dioxide.

Notwithstanding meaningful advances in REE recovery from REE-containing aqueous solutions, complex component separation from solutions containing one or more metals (e.g., a transition metal) in addition to an REE continues to present difficult challenges that have yet to be solved.

Thus, to, inter alia, solve issues of climate change and rare earth resource scarcity, a need remains for novel and improved pathways that will both promote a circular economy and mitigate greenhouse gas emissions, whilst allowing for complex multi-element (e.g., at least an REE and base metal) separation.

While certain aspects of conventional technologies have been discussed to facilitate disclosure of the invention, the Applicant in no way disclaims these technical aspects, and it is contemplated that the claimed invention may encompass one or more of the conventional technical aspects discussed herein.

In this application, where a document, act or item of knowledge is referred to or discussed, this reference or discussion is not an admission that the document, act or item of knowledge or any combination thereof was, at the priority date, publicly available, known to the public, part of common general knowledge, or otherwise constitutes prior art under the applicable statutory provisions; or is known to be relevant to an attempt to solve any problem with which this specification is concerned.

### SUMMARY OF THE INVENTION

Briefly, embodiments of the present invention provide methods for complex component separation of a rare earth metal and optionally an additional metal (e.g., a base metal) from an aqueous solution comprising at least two metals (at least a rare earth metal and a base metal).

In a first aspect, the invention provides a method for recovering a rare earth metal from an aqueous solution comprising at least two metals, said method comprising:
providing an aqueous solution comprising rare earth metal ions from a rare earth metal and base metal ions from a base metal that is a transition metal;
adding a solvent to capture carbon dioxide (CO₂) to the aqueous solution; and
(i) recovering the rare earth metal by:
   introducing a source of (bi)carbonate or carbamate anion into the solution, thereby forming a rare earth metal carbonate;
   forming a soluble base metal complex which enables separation of the rare earth metal; and
   precipitating the rare earth metal carbonate from the aqueous solution, thereby forming a rare earth metal-depleted aqueous solution.

These and other objects, features, and advantages of this invention will become apparent from the following detailed description of the various aspects of the invention taken in conjunction with the accompanying drawings.

### BRIEF DESCRIPTION OF THE DRAWINGS

FIG. 1 is a schematic representation of an embodiment approach to separate lanthanum and nickel by harnessing CO₂.

FIG. 2 is a chart showing lanthanum and nickel extraction effect based on solvent.

FIG. 3 are charts demonstrating evidence of lanthanum carbonate formation based on X-ray Diffraction (XRD) analyses of product at room temperature and post-thermogravimetric analysis (TGA) at 1000° C. obtained by using (a) ammonium hydroxide, (b) monoethanolamine (MEA), and (c) diethylenetriamine (DETA). Triangles indicate lanthanum oxide (La₂O₃) phase, of which the space group is P63/mmc.

FIG. 4 are an a) X-ray diffraction (XRD) analyses and b) a plot. The figure provides evidence of different types of lanthanum carbonate hydrate formation using NH₄OH as the solvent based on a) XRD analyses of the product at room temperature and post-TGA at 1000° C. and b) thermal decomposition behavior of the collected solid.

FIG. 5 depicts wide angle X-ray scattering (WAXS) characterization of lanthanum (La) precipitates via CO₂ purging through La/Ni mixed solution using NH₄OH as the solvent. Shown in a) is a schematic representation of the in-situ experimental setup; b) depicts identification of the crystalline phases as lanthanum carbonate octahydrate (La₂(CO₃)₃·8H₂O) from both in-situ and ex-situ samples. Specific planes are labelled with the miller indices.

FIG. 6 are plots showing lanthanum carbonate formation based on TGA analyses of product obtained by using (a) ammonium hydroxide, (b) MEA, and (c) DETA.

FIG. 7 are plots showing lanthanum carbonate formation based on FTIR analyses of product at room temperature and calcined at 600° C. obtained by using (a) & (d) ammonium hydroxide, (b) & (e) MEA, and (c) & (f) DETA.

FIG. 8 depicts SEM images showing morphologies of (a-1) as-collected lanthanum precipitate using NH₄OH (La-carbonate-NH₄OH), (a-2) La-carbonate-NH₄OH treated at 600° C., (a-3) (La-carbonate-NH₄OH treated at 1000° C., (b-1) as-collected lanthanum precipitate using MEA (La-carbonate-MEA), (b-2) La-carbonate-MEA treated at 600° C., (b-3) (La-carbonate-MEA treated at 1000° C., and (c-1) as-collected lanthanum precipitate using DETA (La-carbonate-DETA), (c-2) La-carbonate-DETA treated at 600° C., (c-3) (La-carbonate-DETA treated at 1000° C. determined using Scanning Electron Micrographs (SEM).

FIG. 9 shows in-situ ultra-small/small angle X-ray scattering (USAXS/SAXS) characterization of a Pt plate electrode in Ni electroplating experiment under an applied voltage (16 V) using NH₄OH as the solvent. a) In-situ USAXS/SAXS pattern; b) a detailed view of the peak shift in the USAXS range (q<3×10⁻⁴ Å).

FIG. 10 provides information from an Ni electrowinning experiment using NH₄OH as the solvent without/with CO₂ purging, a) platinum (Pt) wire electrode image after Ni electroplating in NH₄OH(NH₄OH—Pt), b) morphology of the NH₄OH—Pt wire electrode via scanning electron microscopy (SEM) images, c) phase identification of the NH₄OH—Pt wire electrode via X-ray diffraction (XRD) characterization, d) platinum (Pt) wire electrode after Ni electroplating in NH₄OH+CO₂ bubbling (NH₄OH—CO₂—Pt), e) morphology of the NH₄OH—CO₂—Pt wire electrode via scanning electron microscopy (SEM) images, f) phase identification of the NH₄OH—CO₂—Pt wire electrode via X-ray diffraction (XRD) characterization. Face-center cubic (FCC) Ni metal peaks are identified and labelled with Miller indices.

FIG. 11 provides information about the Pt wire electrode a) fresh platinum (Pt) wire electrode image, b) morphology of the fresh Pt wire electrode via scanning electron microscopy (SEM) images, c) phase identification of the Pt wire electrode via X-ray diffraction (XRD) characterization.

FIG. 12 shows morphology of a) fresh Pt wire electrode, b) NH₄OH—Pt wire electrode, c) NH₄OH—CO₂—Pt wire electrode, and energy-dispersive X-ray spectroscopy (EDS) spectra of d) fresh Pt wire electrode, e) NH₄OH—Pt wire electrode, f) NH₄OH—CO₄—Pt wire electrode via scanning electron microscopy (SEM).

FIG. 13 depicts phase identification of the Ni formation based on different solvents used in the presence/absence of CO₂ purging. a) MEA solvent without CO₂ purging, b) MEA solvent with CO₂ purging, c) DETA solvent without CO₂ purging, d) DETA solvent with CO₂ purging.

FIG. 14 depicts phase identification of several rare earth carbonate hydrate formation in the separation process using NH₄OH as the solvent. a) La/Zn mixed solution, b) Eu/Ni mixed solution, c) Dy/Ni mixed solution, d) Ho/Ni mixed solution.

### DETAILED DESCRIPTION

In the following description, reference is made to the accompanying drawings and text that form a part hereof, and in which is shown by way of illustration specific embodiments which may be practiced. These embodiments are described in detail to enable those skilled in the art to practice the invention, and it is to be understood that other embodiments may be utilized and that structural, logical, and electrical changes may be made without departing from the scope of the present invention. The following and descriptions of example embodiments are, therefore, not to be taken in a limited sense, and the scope of the present invention is defined by the appended claims.

Embodiments of the present invention provide methods that solve issues of climate change and rare earth resource scarcity, namely, by providing novel pathways that promote a circular economy and mitigate greenhouse gas emissions, while enabling recovery of metals, including complex component separation in an electrochemical environment. In some embodiments, the inventive method provides for separation and recovery of an REE and base metal from the same solution via solvent complexing with the base metal that is kept solubilized, thereby enabling reaction between the REE and CO₂ to precipitate the REE from the solution. Some such embodiments advantageously overcome difficulties that inhere to multicomponent separation, particularly in electrochemical environments, including solvent degradation and stability issues.

The terminology used herein is standard terminology in the art and is used as understood by persons of skill in the art.

In one aspect, the invention provides a method for recovering a rare earth metal from an aqueous solution comprising at least two metals, said method comprising:
providing an aqueous solution comprising rare earth metal ions from a rare earth metal and base metal ions from a base metal that is a transition metal;
adding a solvent to capture carbon dioxide (CO₂) to the aqueous solution; and
(i) recovering the rare earth metal by:
   introducing a source of (bi)carbonate or carbamate anion into the solution, thereby forming a rare earth metal carbonate;
   forming a soluble base metal complex which enables separation of the rare earth metal; and
   precipitating the rare earth metal carbonate from the aqueous solution, thereby forming a rare earth metal-depleted aqueous solution.

Rare earth metals include the lanthanides row of the periodic table, scandium, and yttrium: Scandium (Sc), Yttrium (Y), Lanthanum (La), Cerium (Ce), Praseodymium (Pr), Neodymium (Nd), Promethium (Pm), Samarium (Sm), Europium (Eu), Gadolinium (Gd), Terbium (Tb), Dysprosium (Dy), Holmium (Ho), Erbium (Er), Thulium (Tm), Ytterbium (Yb), and Lutetium (Lu).

In particular inventive embodiments, the rare earth metal is lanthanum (La), europium (Eu), dysprosium (Dy), Erbium (Er), or holmium (Ho). In some embodiments, the rare earth metal is La.

In embodiments on the invention, the aqueous solution comprises at least one rare earth metal (e.g., 1, 2, 3, or more rare earth metals). In some embodiments, the solution comprises a single rare earth metal (e.g., La).

In some embodiments, the precipitated rare earth metal carbonate is in tetrahydrate form.

In some embodiments, at least 85 wt % (e.g., at least 85, 86, 87, 88, 89, 90, 91, 92, 93, 94, 95, 96, 97, 98, 99, 99.5, 99.8, or 99.9%, or 100%), including any and all ranges and subranges therein) of the precipitated rare earth metal carbonate is in tetrahydrate form.

In some embodiments, the precipitated rare earth metal carbonate is in lanthanite-La (La₂(CO₃)₃·8H₂O) form.

In some embodiments, at least 85 wt % (e.g., at least 85, 86, 87, 88, 89, 90, 91, 92, 93, 94, 95, 96, 97, 98, 99, 99.5, 99.8, or 99.9%, or 100%), including any and all ranges and subranges therein) of the precipitated rare earth metal carbonate is in lanthanite-La (La₂(CO₃)₃·8H₂O) form.

In embodiments on the invention, the aqueous solution comprises at least one base metal that is a transition metal (e.g., 1, 2, 3, or more base metals). In some embodiments, the solution comprises a single base metal (e.g., Ni).

The IUPAC defines transition metals as an element with a partially-filled d subshell or the capacity to produce cations with an incomplete d subshell.

Transition metals include Scandium, Titanium, Vanadium, Chromium, Manganese, Iron, Cobalt, Nickel, Copper, Zinc, Yttrium, Zirconium, Niobium, Molybdenum, Technetium, Ruthenium, Rhodium, Palladium, Silver, Cadmium, Lutetium, Hafnium, Tantalum, Tungsten, Rhenium, Osmium, Iridium, Platinum, Gold, Mercury, Lawrencium, Rutherfordium, Dubnium, Seaborgium, Bohrium, Hassium, Meitnerium, Darmstadtium, Roentgenium, and Copernicium.

In some embodiments of the invention, the base metal is nickel (Ni), cobalt (Co), zinc (Zn), iron (Fe), or Manganese (Mn). In particular embodiments, the base metal is Ni.

In some embodiments, the recovered base metal (e.g., Ni) is in pure face centered cubic (FCC) form. For example, in some embodiments, at least 85 wt % (e.g., at least 85, 86, 87, 88, 89, 90, 91, 92, 93, 94, 95, 96, 97, 98, 99, 99.5, 99.8, or 99.9%, or 100%), including any and all ranges and subranges therein) of the recovered base metal is in pure FCC form.

In some embodiments, the aqueous solution on which said (i) recovering the rare earth metal is performed contains a molar concentration (mol/L) of rare earth metal of 0.005 to 1 M (for example, 0.005, 0.006, 0.007, 0.008, 0.009, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, 0.51, 0.52, 0.53, 0.54, 0.55, 0.56, 0.57, 0.58, 0.59, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99, or 1.0 M, including any and all ranges and subranges therein (e.g., 0.01 to 0.07 M, 0.02 to 0.06 M, etc.)).

In some embodiments, the aqueous solution on which said (i) recovering the rare earth metal is performed contains a molar concentration (mol/L) of base metal of 0.005 to 1 M (for example, 0.005, 0.006, 0.007, 0.008, 0.009, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, 0.51, 0.52, 0.53, 0.54, 0.55, 0.56, 0.57, 0.58, 0.59, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99, or 1.0 M, including any and all ranges and subranges therein (e.g., 0.005 to 0.04 M, 0.01 to 0.03 M, etc.)).

The solvent used in embodiments of the invention is one that is able to capture carbon dioxide. It is within the purview of a person having ordinary skill in the art to readily identify such solvents, and it is contemplated that all such solvents may be used (alone or in combination) in embodiments of the invention. Various solvents able to capture carbon dioxide are discussed, for example, in R. Wanderley et al., The salting-out effect in some physical absorbents for CO₂ capture, Chemical Engineering Transactions, 69 (2018) 97-102 and P. Singh et al., Solubility of CO2 in Aqueous Solution of Newly Developed Absorbents, Energy Procedia 1 (2009) 1257-1264. Non-limiting examples of solvents to capture carbon dioxide are listed in the following table from P. Singh et al., which shows solvent-screening results for 10 kPa CO₂ partial pressure absorption at 30° C. and regeneration at 90° C., 1 atmosphere.

| | | | | | |
|---|---|---|---|---|---|
| | | Rich | Lean | Cyclic | |
| | Sol- | Loading | loading | loading | |
| | vent | moles | moles | moles | |
| | Con. | CO₂/ | CO₂/ | CO₂/ | Abs. |
| | mole/ | moles | moles | moles | Slope |
| Solvent | L | amine | amine | amine | min⁻¹ |

Reference solvents

| | | | | | |
|---|---|---|---|---|---|
| Monoethanolamine (MEA) | 0.54 | 0.61 | 0.18 | 0.44 | 1.70E−02 |
| MonoethanolamineMEA | 2.53 | 0.52 | 0.27 | 0.25 | 1.01E−02 |
| Diethanolamine (DEA) | 0.48 | 0.66 | 0.18 | 0.48 | 1.45E−02 |
| Diethanolamine (DEA) | 2.60 | 0.50 | 0.25 | 0.25 | 5.29E−03 |
| Diisopropanolamine (DIPA) | 0.58 | 0.61 | 0.18 | 0.43 | 7.63E−03 |
| Diisopropanolamine (DIPA) | 2.81 | 0.42 | 0.19 | 0.22 | 4.45E−03 |
| Piperazine (Pz) | 0.51 | 0.87 | 0.07 | 0.80 | 2.56E−02 |

Effect of chain with OH group

| | | | | | |
|---|---|---|---|---|---|
| 5-Amino-1-pentanol | 2.51 | 0.52 | 0.34 | 0.18 | 7.30E−03 |
| 6-Amino-1-hexanol | 0.51 | 0.58 | 0.18 | 0.40 | 1.46E−02 |

Effect of chain length with CH [symbol] group

| | | | | | |
|---|---|---|---|---|---|
| n-Pentylamine | 2.57 | 0.35 | 0.25 | 0.10 | 1.05E−02 |
| Hexylamine | 0.13 | 0.99 | 0.67 | 0.32 | 3.10E−02 |

Effect of chain length in diamine based solvents

| | | | | | |
|---|---|---|---|---|---|
| 1-3 Diamino propane | 2.53 | 0.97 | 0.78 | 0.19 | 9.74E−03 |
| 1,4-Diaminobutane | 2.58 | 1.09 | 0.87 | 0.22 | 5.64E−03 |
| 1,3-Propanediamine, | 2.56 | 0.95 | 0.54 | 0.41 | 1.46E−03 |
| N,N,N′,N′-tetramethyl | | | | | |
| Hexamethylenediamine | 2.54 | 1.11 | 0.89 | 0.21 | 5.16E−03 |
| 1,6-Hexanediamine, | 0.49 | 1.51 | 0.66 | 0.85 | 1.06E−02 |
| N,N′-dimethyl | | | | | |
| 1,7-Diaminoheptane | 0.51 | 1.34 | 0.53 | 0.81 | 9.92E−03 |

Effect of side chain effect

| | | | | | |
|---|---|---|---|---|---|
| Sec-Butylamine | 2.53 | 0.59 | — | — | 5.42E−03 |
| Iso Butylamine | 2.58 | 0.39 | — | — | 8.40E−03 |
| 1-2-Diamino propane | 2.52 | 0.89 | 0.68 | 0.21 | 9.09E−03 |
| N-(2-Hydroxyethyl) | 2.56 | 0.89 | 0.60 | 0.20 | 9.14E−03 |
| ethylenediamine | | | | | |

Effect of number of NH₂ group

| | | | | | |
|---|---|---|---|---|---|
| Diethylenetriamine | 2.47 | 1.43 | 1.08 | 0.34 | 6.67E−03 |
| 3,3′-Iminobis(N,N- | 2.50 | 1.29 | 0.80 | 0.49 | 7.87E−03 |
| dimethylpropylamine | | | | | |
| N-(2-aminoethyl)1- | 2.54 | 0.92 | 0.57 | 0.35 | 3.33E−03 |
| 3-propane diamine | | | | | |
| Triethylenetetramine | 2.61 | 1.48 | 1.21 | 0.27 | 5.05E−03 |
| Tris (2-aminoethyl) amine | 2.55 | 1.50 | 1.42 | 0.08 | 3.635−03 |

Different cyclic amine

| | | | | | |
|---|---|---|---|---|---|
| 1-Methyl Piperazine | 0.53 | 0.76 | 0.24 | 0.51 | 1.55E−02 |
| Trans Piperazine, 2-5 | 0.57 | 0.93 | 0.44 | 0.49 | 1.18E−02 |
| dimethyl | | | | | |
| 2-(1-Piperazinyl)ethylamine | 2.50 | 1.08 | 0.79 | 0.29 | 5.96E−03 |
| 2-Methyl Piperazine | 0.54 | 0.87 | 0.35 | 0.52 | 2.07E−02 |

[symbol]

indicates data missing or illegible when filed

Further non-limiting examples of solvents to capture carbon dioxide are ammonium hydroxide, N-methylpyrrolidone (NMP), methanol, and mono-ethylene glycol (MEG).

In particular embodiments, the solvent to capture carbon dioxide is an amine solvent.

In some embodiments, the amine solvent is selected from monoethanolamine (MEA), diethylenetriamine (DETA), ammonium hydroxide (NH₄OH), sodium glycinate (NaGly), 2-amino-2-methylpropanol (AMP), and 1,8-diazabicyclo[5.4.0]undec-7-ene (DBU).

In particular embodiments, the solvent to capture carbon dioxide is MEA, DETA, or NH₄OH.

In particular embodiments, the solvent to capture carbon dioxide is NH₄OH.

In some embodiments, the amine solvent is a solvent capable of binding with carbon dioxide.

In some embodiments, a single solvent to capture carbon dioxide is used. In other embodiments, more than one solvent is used (e.g., one or more solvents to capture carbon dioxide, such as 1, 2, or 3 or more solvents).

Inventive methods comprise recovering a rare earth metal by introducing a source of (bi)carbonate or carbamate anion into the solution containing rare earth metal ions and base metal ions.

In some embodiments, the source of (bi)carbonate anion is carbon dioxide (CO₂).

In some non-limiting embodiments, the source of (bi)carbonate anion is a gaseous carrier (e.g., air), having a CO₂ concentration in the range of 400 ppm to 1,000,000 ppm (wherein 1,000,000 ppm represents pure CO₂) (for example, 400, 401, 402, 403, 404, 405, 406, 407, 408, 409, 410, 411, 412, 413, 414, 415, 416, 417, 418, 419, 420, 421, 422, 423, 424, 425, 426, 427, 428, 429, 430, 431, 432, 433, 434, 435, 436, 437, 438, 439, 440, 441, 442, 443, 444, 445, 446, 447, 448, 449, 450, 451, 452, 453, 454, 455, 456, 457, 458, 459, 460, 461, 462, 463, 464, 465, 466, 467, 468, 469, 470, 471, 472, 473, 474, 475, 476, 477, 478, 479, 480, 481, 482, 483, 484, 485, 486, 487, 488, 489, 490, 491, 492, 493, 494, 495, 496, 497, 498, 499, 500, 1000, 2000, 3000, 4000, 5000, 6000, 7000, 8000, 9000, 10000, 11000, 12000, 13000, 14000, 15000, 16000, 17000, 18000, 19000, 20000, 21000, 22000, 23000, 24000, 25000, 26000, 27000, 28000, 29000, 30000, 31000, 32000, 33000, 34000, 35000, 36000, 37000, 38000, 39000, 40000, 41000, 42000, 43000, 44000, 45000, 46000, 47000, 48000, 49000, 50000, 51000, 52000, 53000, 54000, 55000, 56000, 57000, 58000, 59000, 60000, 61000, 62000, 63000, 64000, 65000, 66000, 67000, 68000, 69000, 70000, 71000, 72000, 73000, 74000, 75000, 76000, 77000, 78000, 79000, 80000, 81000, 82000, 83000, 84000, 85000, 86000, 87000, 88000, 89000, 90000, 91000, 92000, 93000, 94000, 95000, 96000, 97000, 98000, 99000, 100000, 200000, 300000, 400000, 500000, 600000, 700000, 800000, 900000, or 1000000 ppm), including any and all ranges and subranges therein.

In some non-limiting embodiments, the source of (bi)carbonate anion is a gaseous carrier (e.g., air), comprising 0.04 volume % (vol. %) to 100 vol % CO₂ (e.g., 0.4, 0.5, 0.6, 0.7, 0.8, 0.9, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 vol % CO₂), including any and all ranges and subranges therein.

In some embodiments, the source of (bi)carbonate anion or carbamate anion is introduced into the aqueous solution via a pressurized gaseous stream.

In some embodiments, the source of carbamate anion is an ionic liquid or another fluid (e.g., with functional nanomaterials) that produces carbamate on CO₂ capture.

In some embodiments of the inventive method, forming a soluble base metal complex which enables separation of the rare earth metal comprises forming a soluble base metal complex which enables high purity separation of the rare earth metal. As used in this context, “high purity” means that the recovered rare earth metal product (e.g., a recovered rare earth metal carbonate or carbonate hydrate) has a purity of at least 90 wt % (e.g., at least 90, 91, 92, 93, 94, 95, 96, 97, 98, 99, 99.5, or 99.9 wt %).

In some embodiments, the recovered rare earth metal product comprises less than 10 wt % of transition metal (e.g., less than 10, 9, 8, 7, 6, 5, 4, 3, 2, 1, 0.5, or 0.1 wt %). For example, in some embodiments, the recovered rare earth metal is lanthanum (e.g., in the form of a lanthanum carbonate hydrates), recovered from a solution containing the La and a base metal (e.g., Ni), and the recovered product (e.g., La₂(CO₃)₃·xH₂O) has a purity of at least 90 wt % and comprises less than 10 wt % base metal (e.g., Ni).

In some embodiments, following said (i) recovering the rare earth metal, the rare earth-metal depleted aqueous solution contains a concentration of less than 0.01 mol/L of the rare earth metal that was recovered (e.g., less than 0.01, 0.009, 0.008, 0.007, 0.006, 0.005, 0.004, 0.003, 0.002, or 0.001 mol/L).

In some embodiments, the rare earth-metal depleted aqueous solution contains a concentration of 0.005 to 1 M base metal (for example, 0.005, 0.006, 0.007, 0.008, 0.009, 0.01, 0.02, 0.03, 0.04, 0.05, 0.06, 0.07, 0.08, 0.09, 0.10, 0.11, 0.12, 0.13, 0.14, 0.15, 0.16, 0.17, 0.18, 0.19, 0.20, 0.21, 0.22, 0.23, 0.24, 0.25, 0.26, 0.27, 0.28, 0.29, 0.30, 0.31, 0.32, 0.33, 0.34, 0.35, 0.36, 0.37, 0.38, 0.39, 0.40, 0.41, 0.42, 0.43, 0.44, 0.45, 0.46, 0.47, 0.48, 0.49, 0.50, 0.51, 0.52, 0.53, 0.54, 0.55, 0.56, 0.57, 0.58, 0.59, 0.60, 0.61, 0.62, 0.63, 0.64, 0.65, 0.66, 0.67, 0.68, 0.69, 0.70, 0.71, 0.72, 0.73, 0.74, 0.75, 0.76, 0.77, 0.78, 0.79, 0.80, 0.81, 0.82, 0.83, 0.84, 0.85, 0.86, 0.87, 0.88, 0.89, 0.90, 0.91, 0.92, 0.93, 0.94, 0.95, 0.96, 0.97, 0.98, 0.99, or 1.0 M, including any and all ranges and subranges therein (e.g., 0.005 to 0.04 M, 0.01 to 0.03 M, etc.)).

In some embodiments, the inventive method comprises, in addition to said (i) recovering the rare earth metal, (ii) recovering the base metal from the soluble base metal complex.

In some embodiments, said (ii) recovering the base metal from the soluble base metal complex comprises recovering the base metal from the rare earth-metal depleted aqueous solution formed following said (i) recovering the rare earth metal.

In some embodiments, during said recovering the base metal, the solvent is being regenerated and CO₂ is being produced.

The base metal may be recovered from the base metal complex in accordance with any art-acceptable manner.

In some embodiments, the base material is recovered by electroplating. For example, in some embodiments, electroplating comprises: providing a substrate having a metallic surface as a cathode; contacting said substrate with the rare earth metal-depleted aqueous solution from (i); and applying an electrical current between said substrate and an anode, thereby depositing a layer of the base metal on said substrate.

In some embodiments, recovery of the base metal results in recovery of 70 to 100 wt % (e.g., 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, or 100 wt %), including any and all ranges and subranges therein, of total base metal present in solution and/or in the soluble base metal complex.

In some embodiment of the inventive method, during the recovering the base metal by electroplating (e.g., during application of the electrical current), carbon dioxide is present in (e.g., is introduced into, such as bubbled into) the rare earth metal-depleted aqueous solution.

In some embodiment of the inventive method, during the recovering the base metal by electroplating (e.g., during application of the electrical current), carbon dioxide is not present in (e.g., is not introduced into) the rare earth metal-depleted aqueous solution.

In some embodiments, the inventive method comprises, after precipitating the rare earth metal carbonate, calcining the precipitated rare earth metal carbonate. In some embodiments, calcining is performed at a temperature of at least 800° C. (for example, at least 800, 810, 820, 830, 840, 850, 860, 870, 880, 890, 900, 910, 920, 930, 940, 950, 960, 970, 980, 990, 1000, 1010, 1020, 1030, 1040, 1050, 1060, 1070, 1080, 1090, or 1100° C.). In some embodiments, calcining is performed at about 1000° C. (e.g., at 1000° C.±10%).

In some embodiments, following calcining, at least 80 wt % (e.g., at least 80, 81, 82, 83, 84, 85, 86, 87, 88, 89, 90, 91, 92, 93, 94, 95, 96, 97, 98, 99, 99.5, 99.8, or 99.9%, or 100%, including any and all ranges and subranges therein) of resulting product is in La₂O₃ phase.

In some embodiments, the inventive method comprises, after precipitating the rare earth metal carbonate from the aqueous solution, washing the rare earth metal carbonate with solvent (e.g., the solvent to capture carbon dioxide, or a different solvent) to alleviate base metal co-extraction.

### Examples

The invention will now be illustrated, but not limited, by reference to the specific embodiments described in the following examples.

### Materials

Lanthanum (III) chloride heptahydrate (LaCl₃·7H₂O), and nickel (II) chloride (NiCl) purchased from Sigma Aldrich are used as the metal source. Diethylenetriamine (Reagent Plus, 99%) procured from Sigma Aldrich, monoethanolamine (C₂H₇NO, Fisher chemical, Laboratory Grade and wt. %>95%) purchased from Fisher Chemical, and ammonium hydroxide solution of both (25%) and (28%) obtained from Honeywell and Sigma-Aldrich are applied as the liquid solvents. Nitric acid (Certified ACS Plus, Fisher Chemical) is used for metal and carbonates dissolution. All the chemicals above are used without further purification.

### Preparation of Metal Solutions and Experiment Approaches

Mixed lanthanum/nickel (La/Ni) solutions were prepared by dissolving lanthanum chloride heptahydrate (LaCl₃·7H2O, 371.37 g/mol) and nickel chloride (NiCl₂, 129.60 g/mol) into the de-ionized water. The concentrations of La and Ni were prepared as 0.04 M and 0.02 M, respectively. To illustrate the effect of amine solvents addition on carbonate formation, a blank experiment was conducted first with only CO₂ bubbling through the pure metal solution. Later, several solvents (diethylenetriamine (DETA), monoethanolamine (MEA), ammonium hydroxide (NH₄OH)) were added into the solutions separately to facilitate the carbonate precipitation. The CO₂ bubbling was kept for several hours to remove the lanthanum (La) completely. Among them, DETA solvent was added at one time while MEA and NH4OH were added slowly and step-wisely to avoid potential Ni precipitate and La hydroxide/carbonate hydroxide formation. The solvent addition was finished after 2-3 hours, and this step could be promoted via a drop-by-drop approach if applied at a much larger scale. A summary of the experiment parameters is listed in Table I. Solid precipitates were then collected via centrifugation and dried in an oven for further characterization. The remaining solutions were later utilized for Ni electroplating experiments.

TABLE I

| | Metal ions | | |
|---|---|---|---|
| Experi- | concen- | | |
| ment | tration | Solvent | Time |
| 1 | 0.02M Ni | No solvent, pure H₂O | 24 hours |
| 2 | | 0.5 ml DETA | 18-20 hours |
| 3 | | 0.5 ml MEA added stepwise | 18-20 hours |
| 4 | 0.04M La | 1.0 ml NH₄OH (25%) or 0.9 | Overnight, |
| | | ml NH₄OH (28%) added | >12 hours |
| | | stepwise | |

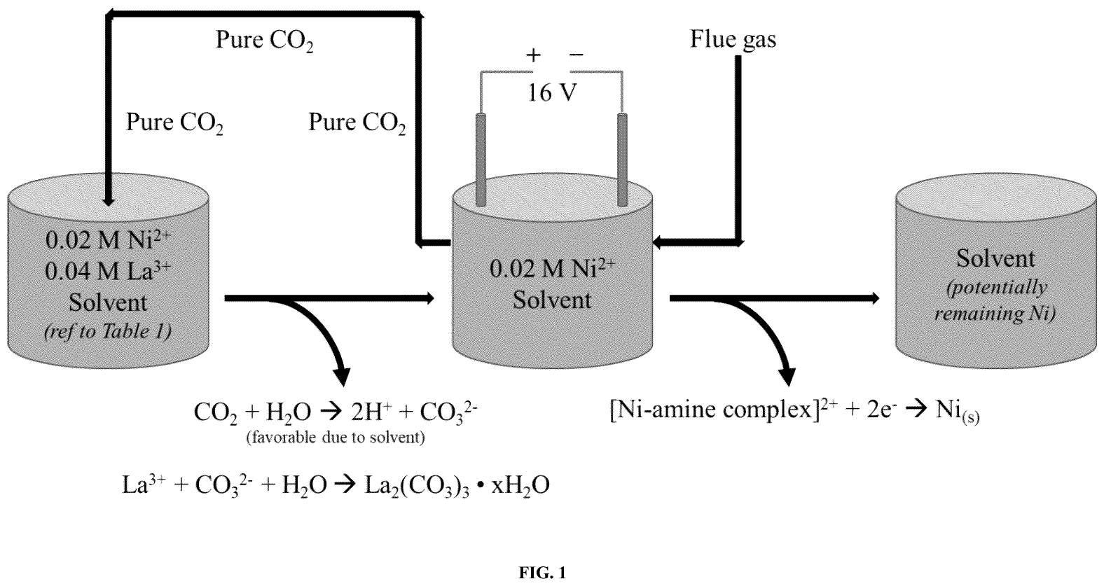

Subsequent Ni electroplating experiments were conducted via a power supply facility (0 V-20 V) in two modes. In the first mode, platinum was utilized for both working and counter electrodes. 16 V was selected as the working voltage to observe the electrowinning effect. The weights of the electrodes are obtained both before and after reactions to quantify the Ni extraction efficiency. The electroplated material is dissolved again in diluted nitric acid (HNO₃) for further analysis. In the second mode, carbon dioxide is also bubbled through the solution during the electrochemical experiment to simulate flue gas purification. A schematic of the overall pathway including both the precipitation and electrowinning steps is shown in FIG. 1.

### Materials Characterization for Carbonate Formation and Ni Electroplating

The thermal behavior of the solid precipitates was determined using a Thermogravimetric Analyzer (TGA, Discovery SDT 650, TA instrument). Samples were heated from room temperature to 1000° C. or more and at a constant N2 flow rate. The crystalline phases of the powders and their products were determined using X-ray diffraction (XRD) analysis (X-ray diffractometer, Bruker D8 Advance ECO powder diffractometer) with Cu Kα radiation (40 kV, 25 mA). The samples were scanned over the 20 range from 20° to 80°. The chemical bonding and functional groups in the synthesized products are evaluated using Fourier Transformed Infrared (FTIR) spectra, acquired in an Attenuated Total Reflection (ATR) mode using an Attenuated Total Reflection-Fourier Transform Infrared spectrometer (ATR-FTIR, Nicolet™ iS50, Waltham, MA). Finally, the morphologies of these samples are observed using a scanning electron microscope (Zeiss LEO 1550 FESEM). These measurements together provide detailed insights into the chemical and morphological transformations of the lanthanum carbonate precipitates under the heat treatment.

To determine quantitative efficiencies for these experiments, concentrations of metal ions in the liquid solutions were determined via the Inductively coupled plasma-optical emission spectrometry (ICP-OES). The collected precipitates were first dried in oven to remove the surface water. Then, part of the solids was dissolved in diluted nitric acid (HNO₃) for ICP-OES analysis. Efficiency was calculated based on several parameters: 1) La concentration from the ICP results, 2) Analyzed volume; 3) Collected solids weight, 4) Dissolved solids weight. The equation for efficiency is as follows:

$$Efficiency = \frac{Precipitated La}{Input La} = \frac{Concentration from ICP \times Analyzed volume \times \frac{Collected weight}{Dissolved weight}}{\begin{matrix}Concentration ( 0.04 \frac{mol}{L} ) \times \\ Volume ( 0.05 L ) \times Atomic mass ( 138.9 \frac{g}{mol} )\end{matrix}}$$

Finally, the crystalline phase identification of lanthanum (La) carbonate via CO₂ bubbling and Ni layer formation in the electrowinning process were also determined using in-situ ultra-small/small/wide-angle X-ray scattering (USAXS/SAXS/WAXS) measurements at room temperature. The experiments were performed at sector 12-ID-C at Advanced Photon Source (APS) in Argonne National Laboratory (ANL). X-ray wavelength during the measurements was 0.59 Å, which corresponds to an X-ray energy of 21.0 keV. Total X-ray photon flux received by the instrument was ˜1013 photon mm-2 s-1. The calibrations for sample-to-detector distance and instrument were performed using LaB₆.

### Yield of Lanthanum Precipitation and Ni Extraction

Lanthanum extraction efficiency is a key parameter in these experiments, and it is expressed here in the form of lanthanum carbonate yield since the lanthanum is confirmed to precipitate in the form of carbonate hydrate, which is discussed below.

In the blank experiment, little precipitate could be collected after the reaction process via centrifugation and the solution still appears to be green, indicating the presence of the nickel ions. Consequently, no carbonate formation was observed in this case, and this phenomenon is attributed to the low solubility of CO₂ in pure water, indicating that amine solvents which can bind with CO₂ are needed. When solvents (NH₄OH, MEA, and DETA) were added into the La/Ni mixed solution, complexes are observed immediately, and they gradually transform into the carbonate hydrate during the reaction. In the end, precipitates were collected via centrifugation and dried in oven for further analyses.

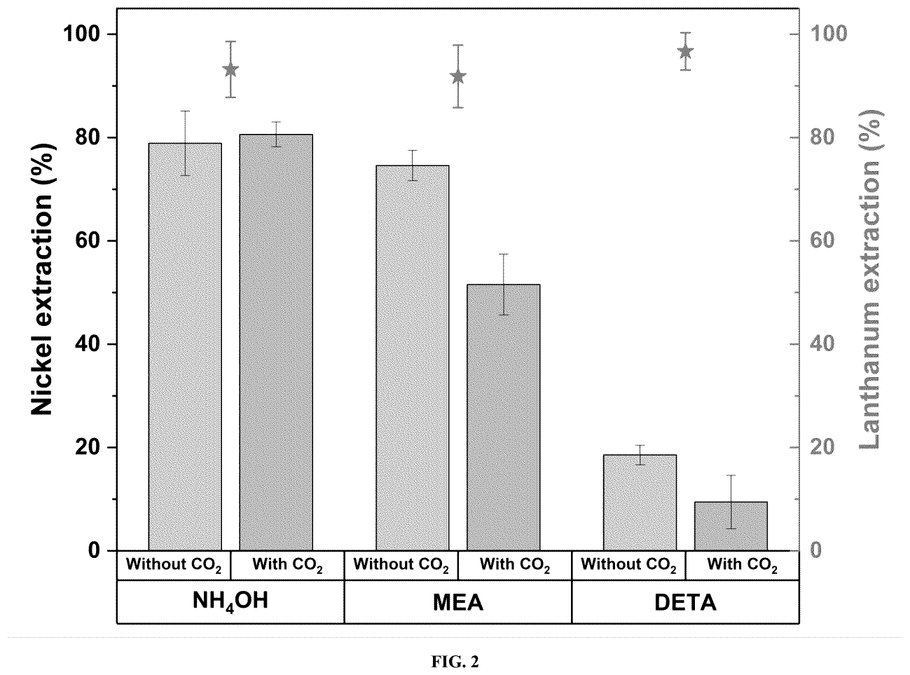

The obtained lanthanum carbonate yield is calculated via the aforementioned equation for efficiency and summarized in FIG. 2. It is clearly shown in the figure that, with the addition of solvents, the lanthanum carbonate yields all reached more than 90%, indicating an efficient precipitation and extraction effect of La using this CO₂ purging method. It was noted from both solids' appearance and ICP analyses that a small amount of nickel from Ni-compounds or attached on the precipitate surface can be extracted with lanthanum in the centrifuge step. The solvent usage amount needs careful determination, which is related to the ions concentrations. This Ni co-extraction can be alleviated by washing the precipitates in solvent (e.g., NH₄OH solutions) for a second time while this may cause further chemical consumption. Out of the three solvents used, DETA has the lowest Ni co-extraction due to its stronger Ni-DETA binding system.

Ni electrowinning efficiency varies based on the solvent with a decreasing average value from NH₄OH to MEA and DETA solution (FIG. 2). Around 80% of Ni was extracted out via the electroplating method in NH₄OH, with most of the Ni existing in the pure FCC Ni metal form and Ni(OH)₂ appearing as a minor phase in some cases. The detailed procedures and analyses are provided in the “Ni extraction in remaining solution via electrowinning method” section below. This high yield separation and collection effect indicates an ability to selectively extract metal ions.

### Chemical Phase Identification of the Collected Solids Via X-Ray Diffraction (XRD) Characterization

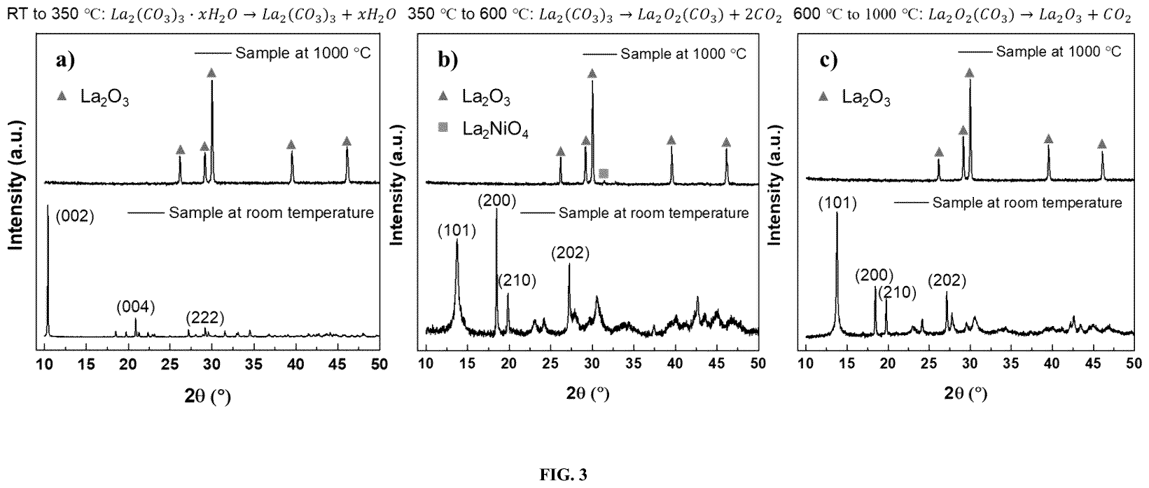

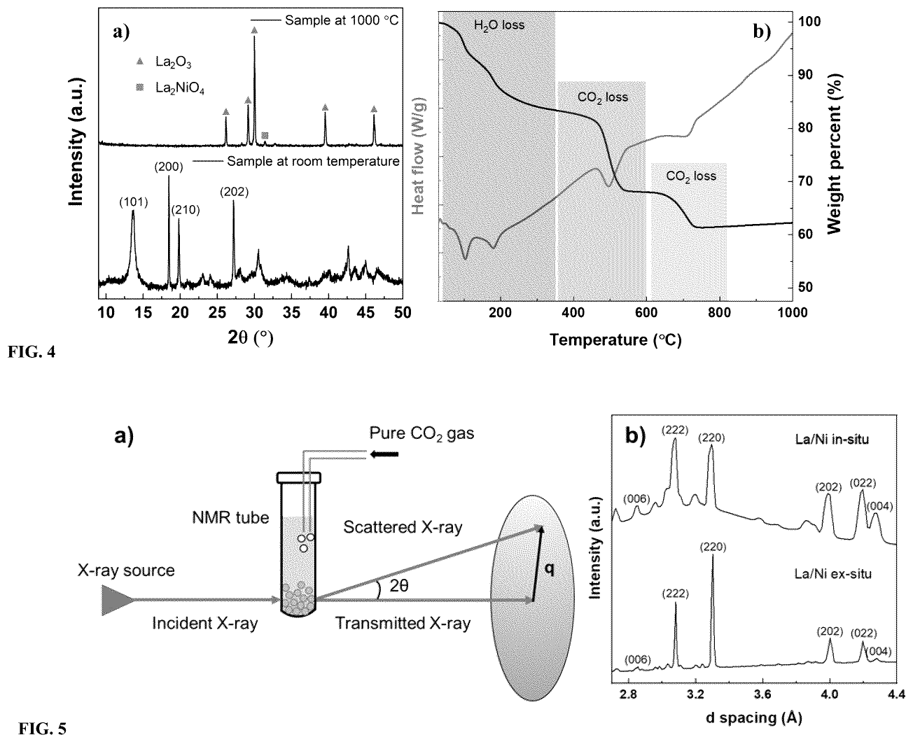

The chemical phases of the dried collected solids as well as its calcination products were analyzed by X-ray diffraction (XRD), starting from 10° to 50°. It is observed that lanthanum precipitates in the lanthanite-La form (La₂(CO₃)₃·8H₂O) using ammonium hydroxide as the solvent (FIG. 3, part A), with a main peak at 10.4°, representing its (002) orientation plane. Other planes like (004), (222), and (224) are marked as well. The XRD patterns of the La-precipitates exhibited similar data curves in the other two solvents as well (FIG. 3, parts B and C). Both patterns matched with (cerium, lanthanum) carbonate tetrahydrate ((Ce,La)₂(CO₃)₃·4H₂O), with several peaks identified as (101), (200), (210), (202), (013) at 13.8°, 18.5°, 19.8°, 27.2°, and 30.6°, respectively. The different types of hydrate formation are believed to be related to the various solvents as well as experimental conditions used, as the lanthanum may also precipitate in the form of La₂(CO₃)₃·4H₂O using NH₄OH (FIG. 4). In addition, different relative intensity of similar peaks observed indicates that the crystallinity of the lattice planes may vary from different experiments and reaction conditions. Calcination samples at 1000° C. can tell the information about the purity of precipitated solids (whether Ni was extracted out at the same time). It is promising to see that, regardless of using ammonium hydroxide, MEA or DETA as solvents, the sample calcined at 1000° C. contains La₂O₃ as the main phase (FIG. 3) and exhibits little indication of a La—Ni compound (like La₂NiO₄). Small impurity peaks are noticed in some cases (FIG. 3, part B and FIG. 4) but the extraction effect of lanthanum is not significantly influenced (FIG. 2). This indicates that La and Ni in a mixed solution could be efficiently separated via this carbonate precipitation approach of using an additional solvent (NH₄OH, MEA, DETA) and CO₂ purging.

Crystalline phase formation of lanthanum (La) carbonate was also verified via the in-situ wide-angle X-ray scattering (WAXS) measurement with CO₂ bubbling. Here, only the NH₄OH case was illustrated. A 0.04 M La/0.02 M Ni mixed solution was prepared first by dissolving lanthanum chloride heptahydrate (LaCl₃·7H₂O) and nickel chloride (NiCl) in the de-ionized water. Then the solution was loaded into an NMR tube and pure CO₂ gas was purged through the solution using a syringe during the reaction. After a 50-minute in-operando experiment, the X-ray beam was shot on the solid precipitate sitting at the bottom of the NMR tube. The schematic representation of this experimental setup is shown in FIG. 5, part A. The pattern collected from the in-situ precipitate was compared to the ex-situ one (FIG. 5, part B), and both samples exhibited a clear crystalline characteristic of the formed solid. Samples are identified as lanthanum carbonate octahydrate (La₂(CO₃)₃·8H₂O) with peaks labelled as (004), (022), (202), (220), (222), and (006) from larger d spacing to smaller side (right to left), respectively. The in-situ sample exhibits some amorphous features from the observed bump and this result further illustrates the crystallization kinetics of this lanthanum precipitate—one hour of purging produces the lanthanum carbonate hydrate, and further aging time mainly focuses on the crystallization process. The crystallization time may vary with the number of ions and the CO₂ purging rate, and faster kinetics of lanthanum precipitation and extraction in this separation method provide the possibility for its application on a larger scale.

### Thermal Decomposition Behavior of the Collected Solids Via a Thermogravimetric Analyzer (TGA)

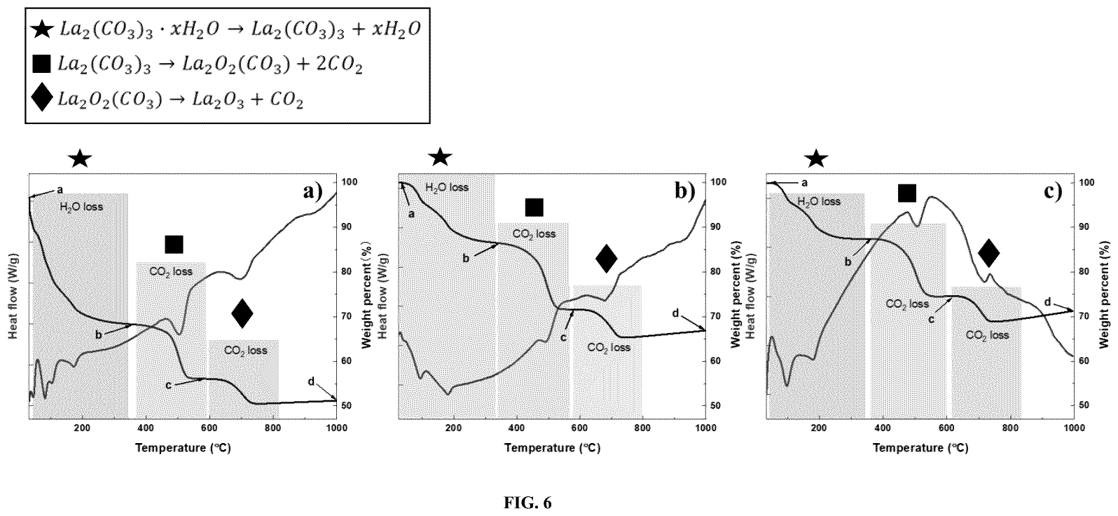

To investigate the thermal decomposition behavior of several lanthanum carbonate hydrate compounds, dried solids were heated in a Thermal analyzer starting from room temperature up to 1000° C. in Na atmosphere at a flow rate of 50 ml/min and the weight losses were investigated based on the mechanisms. A similar phenomenon was observed in all three cases: three obvious weight loss regions are noticed as the samples were heated up (FIG. 6). In the NH₄OH case (FIG. 6, part A), the first weight loss is attributed to the bounded water removal (Equation (1)) to produce the anhydrous lanthanum carbonate (La₂(CO₃)₃). Weight loss in this region accounts for 24% of the sample weight, representing an average of 8H₂O molecules, and this agrees exactly with the XRD characterization in the “Chemical phase identification of the collected solids via X-ray diffraction (XRD) characterization” section above (FIG. 5, part A). In the next step (400° C.-600° C.), lanthanum carbonate releases 2 CO₂ and transforms into La₂O₂(CO₃), and in the final stage (600° C.-800° C.), this decomposes into La₂O₃ by releasing one CO₂ molecule. In both the MEA and DETA scenarios, the first weight loss (before 250° C.), which is attributed to the hydrate water removal, only accounts for 13.5%-14.4% of the initial solid weight. Based on this weight loss, an average of 4H₂O molecules (accurately 3.97-4.3) per hydrate is calculated (FIG. 6, parts B and C); the other two weight losses come again from the CO₂ step loss, during which La₂(CO₃)₃ firstly transforms into La₂O₂CO₃ (Equation (2)), and then into La₂O₃ (Equation (3)).

$$lanthanum carbonate hydrate \to {{La}_{2} ( {CO}_{3} )}_{3} + {x H}_{2} O \qquad Equation ( 1 )$$

$$L {{a}_{2} ( {CO}_{3} )}_{3} \to L {a}_{2} {O}_{2} ( {CO}_{3} ) + 2 {CO}_{2} \qquad Equation ( 2 )$$

$$L {a}_{2} {O}_{2} ( {CO}_{3} ) \to L {a}_{2} {O}_{3} + {CO}_{2} \qquad Equation ( 3 )$$

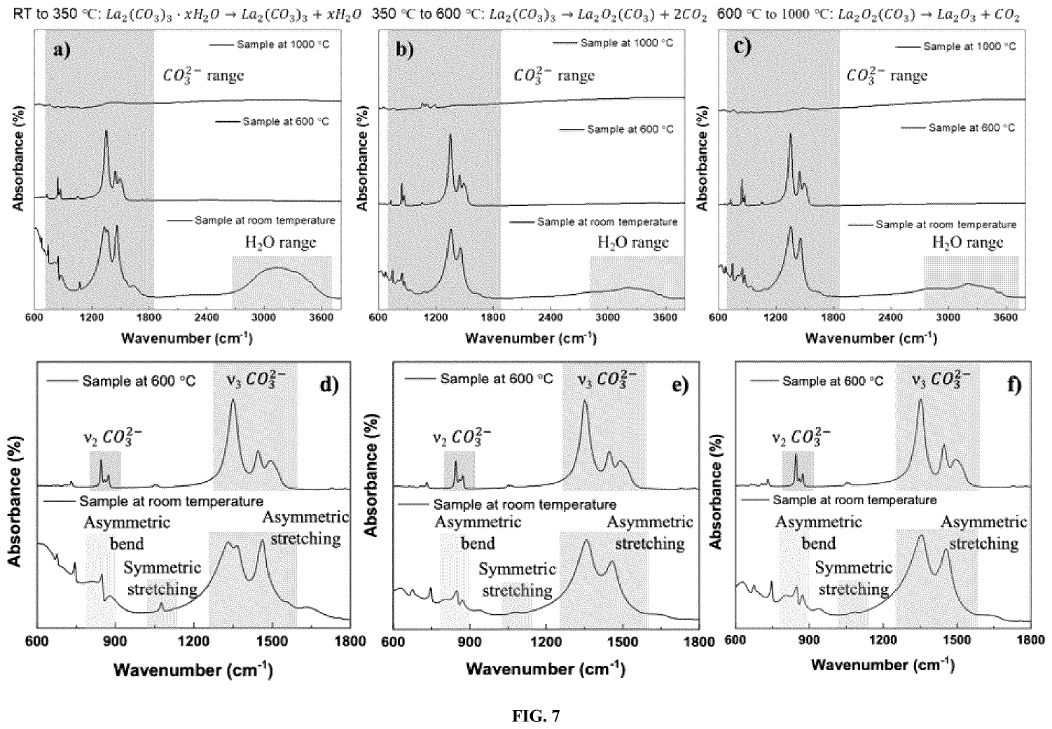

The formation of La₂O₃ as the final calcination product is verified by previous XRD characterizations (FIG. 5) and the La₂O₂ (CO₃) production in the intermediate step is confirmed by Fourier Transformed Infrared (FTIR) spectroscopy (FIG. 7).

### Chemical Bond Analyses of the Collected Solids Using Fourier Transformed Infrared (FTIR) Spectroscopy

Chemical bond breaking and formation plays an important role in solid precipitation, decomposition, and even calcination, which is also determined via the Fourier Transformed Infrared (FTIR) spectroscopy. In this section, the chemical bond analyses were mainly conducted on the initial dried samples (FIG. 6, sample a), their intermediate products (FIG. 6, sample c, calcined at 600° C.), and the final calcination product (FIG. 6, sample d, calcination at 1000° C.) to unveil the phase transformation mechanism.

FTIR patterns of all initial dried samples (sample a) showed clearly that there is a wide broad peak between 2900-3400 cm-1 (FIG. 7, parts A-C, right gray panel), representing the hydrate characteristics. The peaks occurring in the region between 650-1850 cm⁻¹ represents the CO₃²⁻ range (FIG. 7, parts A-C, left gray panel). Detailed information of the peaks is listed below in Table II characteristic peaks around 3000-3600 cm⁻¹ (lattice H2O) vibration), peaks representative of carbonate ions at 747-748 cm⁻¹ (symmetric bend), 848-849 and 871-874 cm⁻¹ (asymmetric bend), 1073-1080 cm⁻¹ (symmetric stretching), 1355-1360 and 1455-1461 cm⁻¹ (asymmetric stretching) (FIG. 7, parts D-F).

For the intermediate product (sample calcined at 600° C.), the three-fold splitting of both v₂ CO₃²⁻ and v₃ CO₃²⁻ of the carbonate (FIG. 7, parts D-F) suggesting monoclinic distortion of the original cell was identified as peaks between 800-900 cm⁻¹ and 1200-1600 cm⁻¹, respectively (Table II). Both H₂O and carbonate characteristics are not observed in the final calcination product (FIG. 7, part A, top line). This result agrees with the analyses from the previous TGA data and illustrates that the carbonate undergoes a first H₂O loss and step CO₂ losses to transform into the lanthanum oxide (La₂O₃).

TABLE II

| Compound | Bond type | Wavenumber (cm⁻¹) |
|---|---|---|
| Lanthanum | lattice H₂O vibration | 3464, 1647 |
| carbonate | carbonate symmetric stretching | 1091 |
| hydrate | carbonate asymmetric stretching | 1473, 1357 |
| | symmetric bend | 749 |
| | asymmetric bend | 880, 850, 806 |
| La₂O₂CO₃ | three-fold splitting of ν₂ CO₃²⁻ | 900-800 |
| | three-fold splitting of ν₃ CO₃²⁻ | 1600-1200 |

### Morphology of Precipitated Lanthanum Carbonate Hydrates and the Corresponding Calcined Products at Different Temperatures

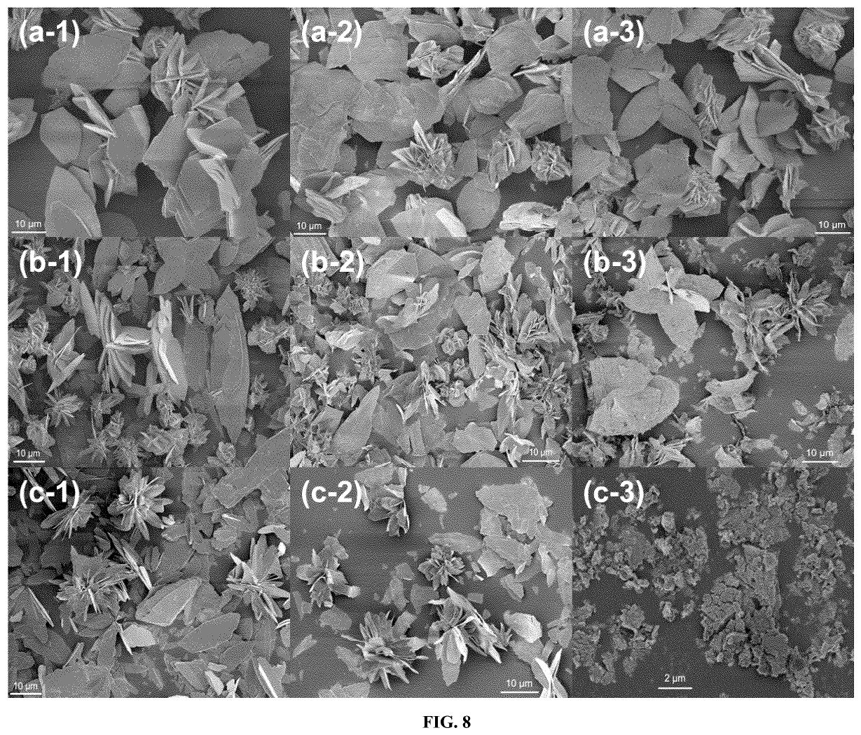

Changes in the morphology of several samples (collected solids, intermediate, and final calcination product) are presented in the images via the scanning electron microscopy (SEM) in FIG. 8. As illustrated above, all lanthanum carbonate hydrates (La₂(CO₃)₃·xH₂O), lanthanum oxycarbonate (La₂O₂CO₃), and lanthanum oxide (La₂O₃) form in slab-like crystals except the lanthanum oxide in DETA case (FIG. 8, except (c-3)). The slabs are approximately 10 microns in length with a thickness of around 1 micron. Some of them are aggregated into clusters, which are shown in these images (FIG. 8). La₂O₃ calcined at 1000° C. in the DETA case (FIG. 8 (c-3)) show a distinct shape from other samples: the samples are existed particle forms instead of slabs observed above, and the particle sizes are less than one micron. This difference is attributed to the different types of solvent usage and the sample behaviors are influenced under the heat treatment.

### Ni Extraction in Remaining Solution Via Electrowinning Method

The aqueous solutions after separation contain mostly Ni ions and amine solvents. To further remove Ni from the solutions, electrowinning approach was applied to them, and Ni was extracted out mainly in the pure Ni metal form.

First, the validity of this approach was verified by an USAXS/SAXS experiment conducted in Argonne National Laboratory. NH₄OH was used as the amine solvent in the study since the ammonium hydroxide could be regenerated by collecting released ammonia (NH₃) and dissolving them back into the water to form ammonium hydroxide (Equation (4)-(6)), while other solvents exhibit different drawbacks regarding this electroplating process (strong affinity of Ni ions with DETA resulting in a low extraction effect, and instability of the MEA solvent during the electroplating process resulting in a potential transformation and non-regeneration of the liquid phase).

$${[ Ni ( {NH}_{3} ) ]}^{2 +} + 2 {e}^{-} \to {Ni}_{( s )} + {n NH}_{3} ( g ) \qquad Equation ( 4 )$$

$$2 {OH}^{-} ( a q ) \to \frac{1}{2} {O}_{2} ( g ) + {H}_{2} O ( l ) + 2 {e}^{-} \qquad Equation ( 5 )$$

$$N {H}_{3} ( g ) + {H}_{2} O ( l ) \to N {H}_{4} OH ( l ) \qquad Equation ( 6 )$$

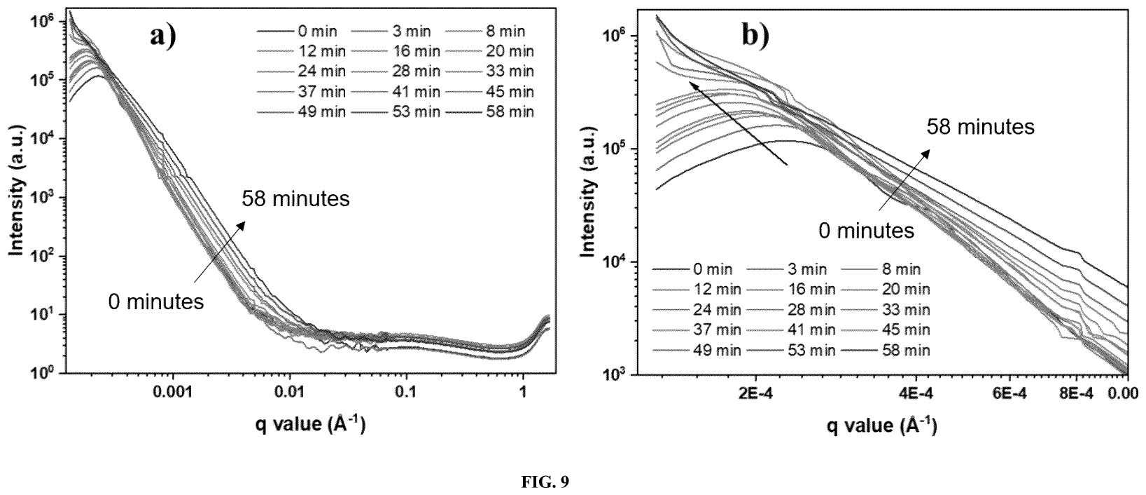

The in-situ Ni electroplating experiment was conducted in a U-shaped cell: 20 ml 0.04 M Ni solution was first prepared and 3.2 ml NH₄OH was added into the solution to form the Ni—NH₃ complex. The Pt plate electrodes were immersed in the solution and linked to a power supply. 16 V was applied to the solution and the X-ray beam was shot at the corner of the Pt plate electrode. The reaction was kept running for almost 1 hour and data was collected and analyzed (FIG. 9).

Two key observations are noted from the merged USAXS/SAXAS curve: 1) the intensity shows an increment as the scan time increases (0.001 Å⁻¹<q<0.01 Å⁻¹), representing new scattering occurrences and more scattering events; 2) peaks at q<3×10⁻⁴ Å are noticed to shift towards lower q value as the scan time increases (FIG. 9, part b), which corresponds to an increase in the real space dimension, and this may be attributed to the increase in the thickness of the Pt plate during the reaction since pure Ni metal is believed to be plated on the surface of the electrode. The in-situ electrowinning experiment further proves the accessibility of this approach to extract Ni out from the separated solutions.

Electroplating Experiment in Pure Ni Containing Solution with/without CO₂ Bubbling

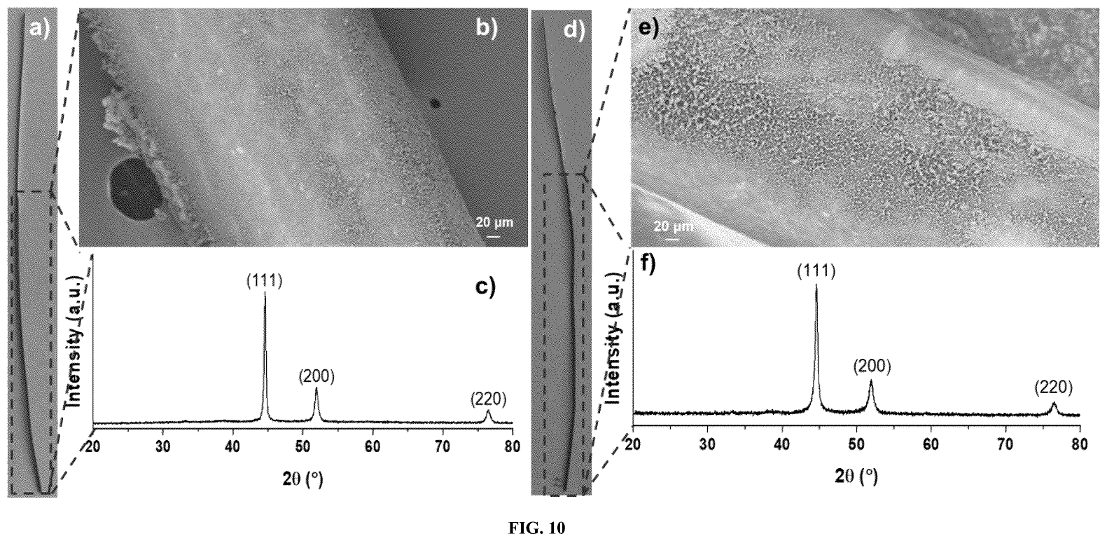

Ammonium hydroxide is considered as a weak base, and the theory that Ni electrowinning experiment mainly utilizes the Ni—NH₃ complex formation provide a kind of possibility to combine Ni electrowinning reaction with CO₂ capture and release process (a purification process). To investigate the CO₂ influence on the electrowinning reaction, the separated solutions after lanthanum (La) extraction were applied in the electrowinning experiments with and without CO₂ bubbling. Platinum (Pt) wires were selected as the working electrode for further SEM characterization on the Ni-plated wires. Ammonium hydroxide was first added to the solution to form [Ni(NH₃)₆]²⁺ ions (changing the solution from green to blue). Then, 16 V voltage was applied to the solutions. The Pt wire working electrode was gradually covered with a black layer during the reaction, and the solution turned into light green or even transparent after certain time periods. More ammonium hydroxide was added at this time to further combine with potential Ni²⁺ ions but little change was noticed. After the reaction, the Pt wires were dried in an oven for morphology investigation and the solids at the bottom of the beaker were collected via a high-speed centrifuge. Liquid solutions afterwards were further sent for ICP analysis to detect the remaining Ni2+ ions concentration. Ni-plated Pt wires, morphology of the plated materials and the phase identification of the extracted solids are shown in FIG. 10.

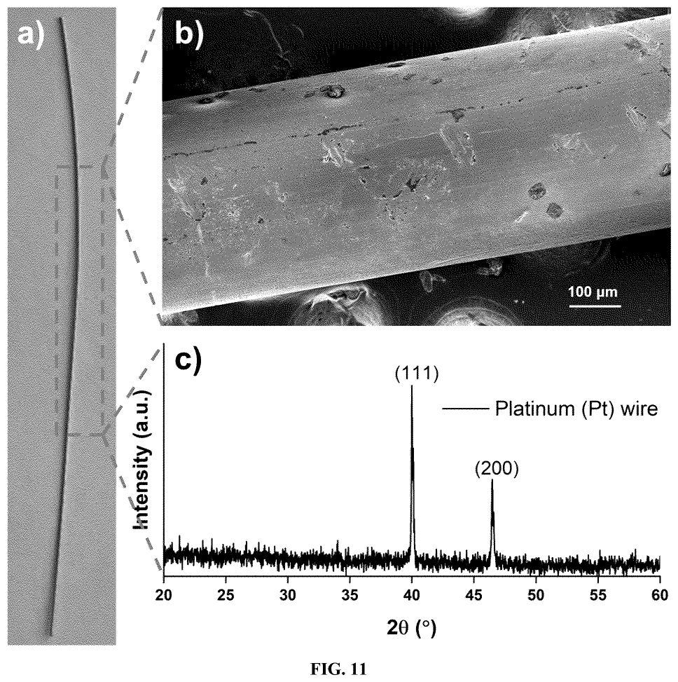

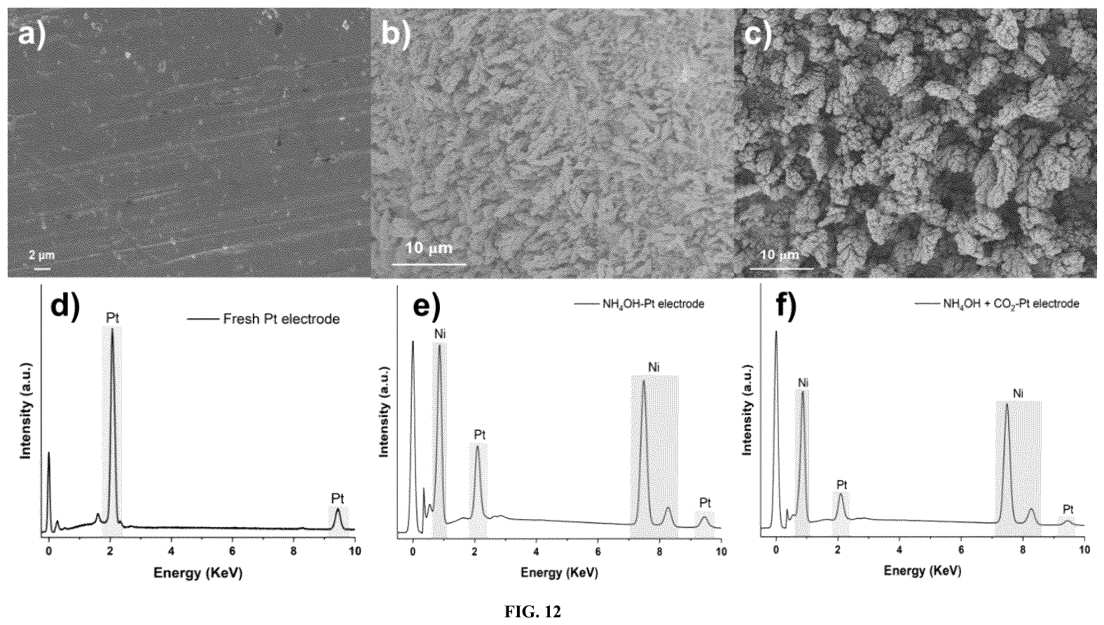

It is clearly shown that a black layer was formed on the Pt wire surface both in the presence/absence of CO₂ bubbling (FIG. 10, parts A and D), which is completely different from the original shiny Pt surface (FIG. 11, part A), indicating a successful electrowinning process. Detailed morphology of the plated materials (FIG. 10, parts B and E) can be observed compared to fresh Pt surface (FIG. 11, part B). Smaller particles are noticed forming on the original smooth surface, which increases its roughness, and the particles are in a wide variety of shapes and micron sizes (FIG. 12, parts A-C). Energy-dispersive X-ray spectroscopy illustrates that the plated materials contained Ni as the main element (FIG. 12, parts D-F) with Pt as the electrode material and it is found that Ni mainly exists in the pure metal form (FIG. 10, parts C and F). Ni could be extracted in the Ni(OH)₂ form in some cases, which is attributed to the Ni ions binding to the OH⁻ ions.

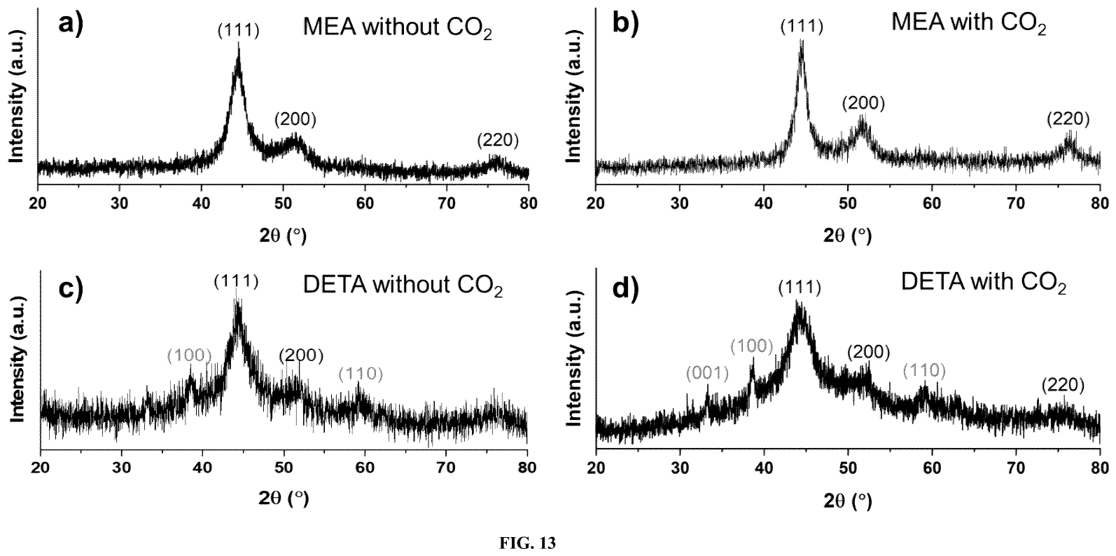

Electroplating experiments conducted in MEA and DETA solutions show similar results in phases formation (FIG. 13) with pure Ni metal as the main chemical phase. Still, Ni(OH)2 exists as a minor phase or an impurity (FIG. 13, parts C and D). In some cases, Ni(OH)₂ percentage is not obtained from the XRD data due to its low value and Ni extraction will be a little bit higher if calculated based on the assumption that all extracted Ni exist in metallic phase. This error possibly takes up 5-10% of the result. A much lower Ni extraction yield is obtained using DETA as the solvent due to the stronger Ni-DETA bond strength. Using MEA as the solvent could produce similar amount of Ni, but the solution turns from blue to brown after the process, indicating an irreversible transformation of MEA solvent during the electroplating which makes this approach not economically viable on a large scale.

It is also interesting to observe that the CO₂ purging through the solvents during electrowinning process leads to quite different results: a decrease in the Ni extraction yield is observed in both MEA and DETA solvents while no decrease is observed in NH₄OH case. This is explained by the higher affinity of NH₃ to Ni ions compared to dissolved CO₂. In this case, dissolved CO₂ only reacts with OH-ions to form carbonate ions while Ni—NH₃ complex remains stable in the solution and produces pure Ni metal layer during the electrowinning reaction.

Based on this observation, a hypothesis can be made that combining this Ni electrowinning approach with a CO₂ purification process via the CO₂ bubbling through the solution during the reaction is viable. Flue gas containing CO₂ as well as other contaminants could be bubbled through the solution, and CO₂ will combine with NH₃ to form a complex. The cathode equation remains the same as equation (4), the anode equation adds in the release of a pure CO₂ stream (Equation (7)) if the anode material is made from certain metals (i.e. Ni)

$${[ Ni ( {NH}_{3} ) ]}^{2 +} + 2 {e}^{-} \to {Ni}_{( s )} + {n NH}_{3} ( g ) \qquad Equation ( 4 )$$

$$Ni \to {Ni}^{2 +} + 2 {e}^{-} ; {Ni}^{2 +} + {n NH}_{3} - {CO}_{2} \to {[ N i ( N {H}_{3} ) ]}^{2 +} + {n CO}_{2} \qquad Equation ( 7 )$$

Potential Utilization of this Approach in Other Separation Process

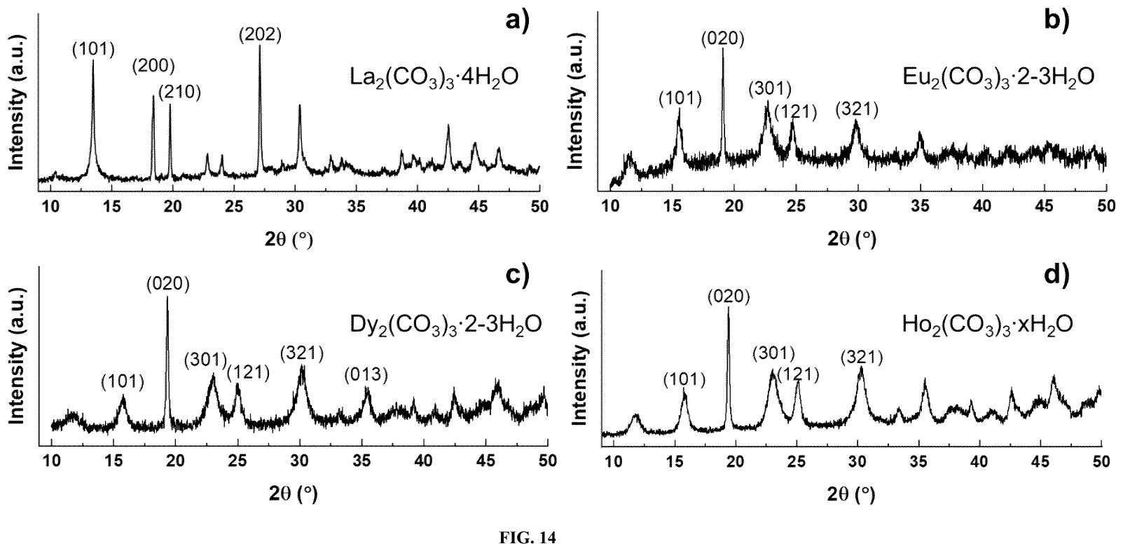

Besides La and Ni, many other rare earth elements were investigated using a similar approach to that described above including Europium (Eu), Dysprosium (Dy), Erbium (Er), and Holmium (Ho). Lanthanum was also studied with other transition metal ions such as Cobalt (Co) or Zinc (Zn). With a proper NH₄OH amount addition, certain rare earth carbonate hydrates could form while the precipitates are always not well crystallized. Several formed carbonate hydrates phase identification have been investigated via X-ray diffraction (XRD) technique (FIG. 14). Lanthanum always precipitates in the form of tetrahydrate while for Europium (Eu), Dysprosium (Dy) or Holmium (Ho), the precipitates crystallized isotypic to tengerite [Y2(CO3)3·2H2O] from the similar peak positions (FIG. 14, parts B-D) (Rincke, Schmidt, and Voigt 2017).

### CONCLUSIONS

For all three tested solvents, more than 90+% precipitation of lanthanum was achieved, indicating the separation of lanthanum and nickel from stock solutions. However, each solvent had varying degrees of electroplating efficiency, which is attributed to the difference in strength/solubility of Ni-DETA, Ni-MEA, and Ni—NH₃ complexes in the presence of a current. Separate experiments for nickel electroplating with and without carbon dioxide indicate the potential for solvent regeneration (i.e., solutions post-electroplating may be used again for lanthanum and nickel separation). The testing described herein demonstrates a novel method for the separation of rare earth metals and transition base metals (e.g., lanthanum and nickel) in stock solutions.

Embodiments of the inventive method are distinguished from the disclosures within the List of References that precedes the claims, each of which is hereby incorporated herein by reference.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), “contain” (and any form contain, such as “contains” and “containing”), and any other grammatical variant thereof, are open-ended linking verbs. As a result, a method or product, composition, etc. that “comprises”, “has”, “includes” or “contains” one or more steps or elements possesses those one or more steps or elements, but is not limited to possessing only those one or more steps or elements. Likewise, a step of a method or an element of a composition or article that “comprises”, “has”, “includes” or “contains” one or more features possesses those one or more features, but is not limited to possessing only those one or more features.

As used herein, the terms “comprising,” “has,” “including,” “containing,” and other grammatical variants thereof encompass the terms “consisting of” and “consisting essentially of.”

The phrase “consisting essentially of” or grammatical variants thereof when used herein are to be taken as specifying the stated features, integers, steps or components but do not preclude the addition of one or more additional features, integers, steps, components or groups thereof but only if the additional features, integers, steps, components or groups thereof do not materially alter the basic and novel characteristics of the claimed composition, device or method.

All publications cited in this specification are herein incorporated by reference as if each individual publication were specifically and individually indicated to be incorporated by reference herein as though fully set forth.

Subject matter incorporated by reference is not considered to be an alternative to any claim limitations, unless otherwise explicitly indicated.

Where one or more ranges are referred to throughout this specification, each range is intended to be a shorthand format for presenting information, where the range is understood to encompass each discrete point within the range, and further to encompass any subrange within the range between any discrete point within the range and any other discrete point within the range, as if the same were fully set forth herein.

1. A method for recovering a rare earth metal from an aqueous solution comprising at least two metals, said method comprising:
providing an aqueous solution comprising rare earth metal ions from a rare earth metal and base metal ions from a base metal that is a transition metal;
adding a solvent to capture carbon dioxide (CO₂) to the aqueous solution; and
(i) recovering the rare earth metal by:
introducing a source of (bi)carbonate or carbamate anion into the solution, thereby forming a rare earth metal carbonate;
forming a soluble base metal complex which enables separation of the rare earth metal; and
precipitating the rare earth metal carbonate from the aqueous solution, thereby forming a rare earth metal-depleted aqueous solution.

2. The method according to claim 1, further comprising:
(ii) recovering the base metal from the soluble base metal complex.

3. The method according to claim 2, wherein during said recovering the base metal, the solvent is being regenerated, and CO₂ is being produced.

4. The method according to claim 2, wherein the base metal is recovered by electroplating, comprising:
providing a substrate having a metallic surface as a cathode;
contacting said substrate with the rare earth metal-depleted aqueous solution; and
applying an electrical current between said substrate and an anode, thereby depositing a layer of the base metal on said substrate.

5. The method according to claim 1, wherein the rare earth metal is lanthanum (La), europium (Eu), dysprosium (Dy), Erbium (Er), or holmium (Ho).

6. The method according to claim 5, wherein the rare earth metal is La.

7. The method according to claim 6, wherein La in the precipitated rare earth metal carbonate is in tetrahydrate form.

8. The method according to claim 6, wherein at least 85 wt % of the precipitated rare earth metal carbonate is in lanthanite-La (La₂(CO₃)₃·8H₂O) form.

9. The method according to claim 1, comprising, after said precipitating the rare earth metal carbonate, calcining the precipitated rare earth metal carbonate.

10. The method according to claim 9, wherein, following said calcining, at least 80 wt % of resulting product is in La₂O₃ phase.

11. The method according to claim 1, wherein the base metal is nickel (Ni), cobalt (Co), zinc (Zn), iron (Fe), or manganese (Mn).

12. The method according to claim 11, wherein the base metal is Ni.

13. The method according to claim 12, wherein at least 85 wt % of recovered Ni base metal is in pure face centered cubic (FCC) form.

14. The method according to claim 1, wherein the solvent to capture carbon dioxide CO₂ is an amine solvent.

15. The method according to claim 14, wherein the amine solvent is a solvent capable of binding with carbon dioxide (CO₂).

16. The method according to claim 14, wherein the amine solvent comprises ammonium hydroxide (NH₄OH).

17. The method according to claim 1, wherein the source of (bi)carbonate anion is carbon dioxide (CO₂).

18. The method according to claim 1, comprising, after said precipitating the rare earth metal carbonate from the aqueous solution, washing the rare earth metal carbonate with amine solvent to alleviate base metal co-extraction.

19. The method according to claim 1, wherein:
the rare earth metal is lanthanum (La), europium (Eu), dysprosium (Dy), Erbium (Er), or holmium (Ho);
the base metal is nickel (Ni), cobalt (Co), zinc (Zn), iron (Fe), or manganese (Mn);
the solvent to capture carbon dioxide CO₂ is an amine solvent; and
during said recovering the base metal, the solvent is being regenerated, and CO₂ is being produced.

20. The method according to claim 19, further comprising:
(ii) recovering the base metal from the soluble base metal complex.

21. The method according to claim 20, wherein the rare earth metal is La and the base metal is Ni.

22. The method according to claim 21, wherein La in the precipitated rare earth metal carbonate is in tetrahydrate form.

23. The method according to claim 21, wherein at least 85 wt % of recovered Ni base metal is in pure face centered cubic (FCC) form.

24. The method according to claim 21, wherein the amine solvent is ammonium hydroxide (NH₄OH).

25. The method according to claim 22, wherein at least 85 wt % of the precipitated rare earth metal carbonate is in lanthanite-La (La₂(CO₃)₃·8H₂O) form.

26. The method according to claim 24, wherein at least 85 wt % of the precipitated rare earth metal carbonate is in lanthanite-La (La₂(CO₃)₃·8H₂O) form.
